(19) United States
(12) Patent Application Publication
(10) Pub. No.: US 2026/0219078 A1
(43) Pub. Date: Jul. 30, 2026

(54) AUTONOMOUS DRIVING DEVICE AND IDENTIFICATION REINFORCEMENT UNIT DETACHABLE THEREFROM

(71) Applicant: Samsung Electronics Co., Ltd., Suwon-si (KR)

(72) Inventors: Shinpil YOON, Suwon-si (KR); Minsong KIM, Suwon-si (KR); Hwanyong KIM, Suwon-si (KR); Sangyul YANG, Suwon-si (KR); Howon CHEONG, Suwon-si (KR)

(21) Appl. No.: 19/629,654

(22) Filed: Mar. 26, 2026

Related U.S. Application Data
(63) Continuation of application No. PCT/KR2024/019722, filed on Dec. 4, 2024.

(30) Foreign Application Priority Data
Dec. 22, 2023 (KR) 10-2023-0190123

(51) Int. Cl. G01D 11/24

(52) U.S. Cl. CPC G01D 11/245

(57) ABSTRACT

An autonomous driving device may include: a first body; a second body spaced apart from the first body; a support supported by the second body on the first body; a sensor positioned in a separation space formed between the first body and the second body; and an identification reinforcement unit positioned in a blind area within the sensing area of the sensor and obscured by the support, wherein the identification reinforcement unit is configured to be identified by an external identification entity comprising circuitry configured to perform position identification, and reinforce identifiability for position identification.

### CROSS-REFERENCE TO RELATED APPLICATIONS

This application is a continuation of International Application No. PCT/KR2024/019722 designating the United States, filed on December 4, 2024, in the Korean Ministry of Intellectual Property Receiving Office and claiming priority to Korean Patent Application No. 10-2023-0190123, filed on December 22, 2023, in the Korean Ministry of Intellectual Property, the disclosures of each of which are incorporated by reference herein in their entireties.

### BACKGROUND

### FIELD

The disclosure relates to an autonomous driving apparatus and an identification reinforcement unit detachable from the autonomous driving apparatus.

### DESCRIPTION OF RELATED ART

Autonomous driving vehicles may recognize surroundings on pre-set driving paths and determine a driving path based therefrom. Taking into consideration that the above-described autonomous driving vehicles are relatively expensive, there is a need to reduce maintenance, repair, and management costs that arise due to damage while operating.

Further, there is a need to not only prevent/reduce in advance damage occurring to the autonomous driving vehicles, but also damage to a subject of collision due to the autonomous driving vehicles. Typically, when such autonomous driving vehicle is operated in plurality, the need for the above may only become greater.

### SUMMARY

According to an example embodiment of the disclosure, an autonomous driving apparatus includes: a first body, a second body separated from the first body, a support configured to support the second body on the first body, a sensor positioned in a separated space between the first body and the second body, and an identification reinforcement portion positioned on a blind area obscured by the support among a sensing area of a sensor, wherein the identification reinforcement comprising a longitudinal piece is configured to be identified by an external identification entity configured to perform position identification, and reinforce identifiability for the position identification.

According to an example of the disclosure, an identification reinforcement unit detachable from an autonomous driving apparatus includes: first identification reinforcement parts positioned between support portions and a sensor, respectively, and an identification reinforcement portion including a second identification reinforcement part positioned between an edge portion on a top surface of a first body and a support portion, and the identification reinforcement portion is configured for identification by an external identification entity configured to perform position identification, and to reinforce identifiability for position identification, and the first identification reinforcement part and the second identification reinforcement part are provided to be protruded toward an upper direction in a pre-set thickness on a top surface of the first body.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an autonomous driving apparatus according to various example embodiments;

FIG. 2 is a diagram illustrating an autonomous driving apparatus according to various example embodiments;

FIG. 3 is a diagram illustrating a plan view of a state in which a sensor, a support portion, and an identification reinforcement portion are positioned on a first body among configurations of an autonomous driving apparatus according to various example embodiments;

FIG. 4 is a diagram illustrating an example method by which an identification reinforcement portion on a first body provides position information to an external identification entity among configurations of an autonomous driving apparatus according to various example embodiments;

FIG. 5 is a diagram illustrating a front view of an example of positions for each configuration of an autonomous driving apparatus according to various example embodiments;

FIG. 6 is a diagram illustrating a side view of an example of positions for each configuration of an autonomous driving apparatus according to various example embodiments;

FIG. 7 is a block diagram illustrating an example configuration of an autonomous driving apparatus according to various example embodiments;

FIG. 8 is a diagram illustrating a plane view of a top surface of a first body according to various example embodiments;

FIG. 9 is a diagram illustrating a top surface of a first body of an autonomous driving apparatus according to various example embodiments;

FIG. 10, FIG. 11, and FIG. 12 are perspective views illustrating a first body among configurations of an autonomous driving apparatus according to various example embodiments;

FIG. 13 and FIG. 14 are perspective views illustrating a state in which an upper plate is installed in an autonomous driving apparatus according to various example embodiments;

FIG. 15 and FIG. 16 are perspective views illustrating a state in which an upper cover is installed at a top surface of a first body according to various example embodiments;

FIG. 17 is a perspective view illustrating an example of a form of an identification reinforcement portion and a support portion according to various example embodiments;

FIG. 18 is a diagram illustrating an example of a form of an identification reinforcement portion and a support portion according to various example embodiments;

FIG. 19 is a diagram illustrating an example of a form of an identification reinforcement portion according to various example embodiments;

FIG. 20 and FIG. 21 are diagrams illustrating an example operating state of an autonomous driving apparatus according to various example embodiments;

FIG. 22 is a perspective view illustrating an exterior of an autonomous driving apparatus according to various example embodiments;

FIG. 23 is a diagram illustrating a plan view of a portion of an autonomous driving apparatus according to various example embodiments;

FIG. 24, FIG. 25, FIG. 26, and FIG. 27 are partial perspective views illustrating an example of a position at which an identification reinforcement portion of an autonomous driving apparatus is installed according to various example embodiments;

FIG. 28 is a diagram illustrating an autonomous driving apparatus according to various example embodiments;

FIG. 29 is a diagram illustrating a plan view of a state in which a sensor, a support portion, and an identification reinforcement portion are positioned on a first body among configurations of an autonomous driving apparatus according to various example embodiments;

FIG. 30 is a diagram illustrating a plan view of a state in which configurations of an autonomous driving apparatus are positioned according to various example embodiments;

FIG. 31 and FIG. 32 are diagrams illustrating plan views of an example method by which cloud points of an autonomous driving apparatus are set according to various example embodiments; and

FIG. 33 is a diagram illustrating a plan view of a state in which configurations of an autonomous driving apparatus are positioned according to various example embodiments.

### DETAILED DESCRIPTION

Embodiments described in the disclosure and configurations shown in the drawings are merely example embodiments, and there may be various modifications that can substitute the example embodiments and drawings of the disclosure.

In the disclosure, like reference numerals or symbols shown in each drawing indicate components or elements that perform substantially the same function.

Terms used in the disclosure have been used to describe various examples, and are not intended to limit the disclosure. A singular expression includes a plural expression, unless otherwise specified. It is to be understood that the terms such as “have” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

Terms that include ordinal numbers such as “first” or “second” used in the disclosure may be used in describing various elements, but the elements are not to be limited by the terms, and the terms may be used for the purpose of distinguishing one element from another element. For example, a first element may be designated as a second element without departing from the scope and spirit of the present disclosure, and similarly, the second element may also be designated as the first element. The term “and/or” may include a combination of a plurality of related items listed together or any item among a plurality of related items listed together.

Terms such as “front end”, “rear end”, “upper portion”, “lower portion”, “front surface”, “rear surface”, “top surface”, “bottom surface”, “top end”, “bottom end”, “one end”, “other end”, “left side”, and “right side” used in the disclosure have been defined based on the drawings, and shapes and positions of each element are not limited by the terms.

A support portion, as a designation of a configuration used below, may perform a role of connecting a first body and a second body with each other and support a separation therebetween. In the disclosure, the configuration that performs the above-described role has been described as the support portion, but may be referred to in various designations such as a support, a pillar portion, a bearing portion, a mounting portion, and a connection portion.

An identification reinforcement portion in the disclosure may be a structure that is a subject to identification by an identification entity, and may be included in a part that performs identification between both an autonomous driving apparatus and an external identification entity (e.g., other autonomous driving apparatus, etc.) in the disclosure. In the disclosure, the above has been described as the identification reinforcement portion, but may be referred to in various designations such as a mechanism, a structure, and an identification in addition thereto.

An autonomous driving apparatus according to various example embodiments will be described in greater detail below with reference to the accompanying drawings.

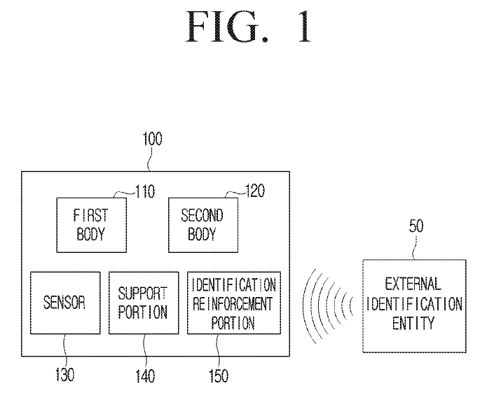

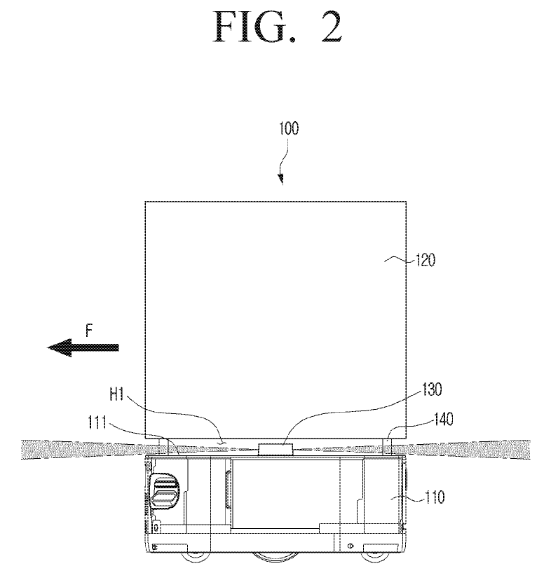

Referring to FIG. 1 and FIG. 2, an autonomous driving apparatus 100 may include a first body 110, a second body 120, a sensor 130, a support portion (e.g., support) 140, and an identification reinforcement portion 150. The autonomous driving apparatus 100 may be an apparatus capable of driving autonomously without human intervention.

The autonomous driving apparatus 100 may be otherwise variously referred such as a driving robot and an unmanned mobile robot. The autonomous driving apparatus 100 may be variously implemented such as a cleaning robot, a mobile projector, a serving robot, an industrial robot, and the like according to its use.

The first body 110 and the second body 120 have partially divided an exterior of the autonomous driving apparatus 100. In the disclosure, the first body 110 has been indicated as disposed at a lower side thereof, and the second body 120 has been indicated as disposed at an upper side thereof.

At the lower portion of the first body 110, wheels for moving the autonomous driving apparatus 100 may be disposed, and at an inside of the first body 110, a driving motor for rotating the wheels, gears, shafts, and the like may be provided.

The second body 120 of the autonomous driving apparatus 100 may be provided to be separated from the first body 110 described above. The support portion 140 of the autonomous driving apparatus 100 may be a configuration for supporting the second body 120 on the first body 110.

The support portion 140 may include a first support portion 141 and a second support portion 142. The support portion 140 may be otherwise referred to as a connection portion or an intermediate portion, and may be referred to as a third body separately from the first body and second body.

The second body 120 described above may be implemented in a structure that is separable from and connectable with the first body 110 based on the support portion 140, or implemented in a structure integrated with the first body 110 and the support portion 140.

Between the first body 110 and the second body 120 of the autonomous driving apparatus 100, a predetermined separated space is formed. The sensor 130 of the autonomous driving apparatus 100 may be positioned in the separated space between both the first body 110 and the second body 120 and perform a position identification operation (e.g., sensing operation, etc.).

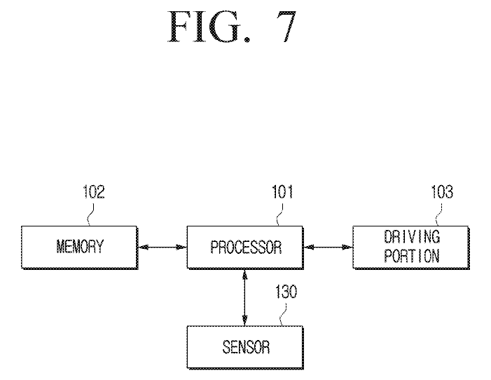

A processor 101 of the autonomous driving apparatus 100 (referring to FIG. 7) may include various processing circuitry and obtain various information such as, for example, and without limitation, a form of a space in which the autonomous driving apparatus 100 is positioned, a position of the autonomous driving apparatus 100 in the space, a position of a surrounding object, a form of a surrounding object, a distance with a surrounding object, and the like based on sensing values of the sensor 130.

The sensor 130 may include at least one among various sensors such as, for example, and without limitation, a LiDAR sensor, an Infra Red (IR) sensor, an ultrasonic sensor, and the like. If the sensor 130 includes the LiDAR sensor, the LiDAR sensor may rotate 360 degrees with respect to the space in which the autonomous driving apparatus 100 is positioned and irradiate a laser.

When the laser is reflected from objects surrounding the autonomous driving apparatus 100 and received back to the LiDAR sensor, the LiDAR sensor may provide data such as received time or received direction to the processor.

The processor 101 (referring to FIG. 7) may measure a distance with an object based on the data described, and generate data points of the surrounding environment by performing distance measurement from various angles and directions. The data points described may be generated in a form of cloud points. Each of the cloud points may include information on 3D coordinate values.

Although it is typical for the cloud points to include information on 2D coordinate values, information on 3D coordinate values may also be included. The processor may form the generated information in a map form and store in memory 102 (referring to FIG. 7), and utilize the stored map when setting a driving path or when driving.

In an operation of the autonomous driving apparatus 100 as described above, the role of the sensor 130 for identifying accurate positions is important. Accordingly, because there is a need to not block the sensing range of the sensor 130 as much as possible, structures that interfere with sensing in the surrounding of the sensor 130 are typically not installed.

However, the structures as described may cause collision accidents in an environment in which the autonomous driving apparatus 100 is used together with other autonomous driving apparatuses of the same type. In other words, if a plurality of autonomous driving apparatuses 100 disposed with sensors 130 at same heights are used together, only the sensor 130 installed in the other autonomous driving apparatus may be included in the sensing range of the sensor 130.

If the sensor 130 is disposed at the center portion on the exterior of the autonomous driving apparatus 100 and thereby, even if the sensor 130 recognizes the distance from the other autonomous driving apparatus to the sensor, because only the distances between the plurality of autonomous driving apparatuses 100 and the center portion can be recognized, edge portions of the autonomous driving apparatus 100 may be positioned more closely. Thereby, collisions may occur.

If a size of the sensor 130 is small, recognition by the sensor of the other autonomous driving apparatus may not be carried out from a somewhat far distance. Accordingly, collisions as a result therefrom may also occur.

Taking into consideration the above, in various embodiments of the disclosure, the identification reinforcement portion 150 recognizable from the sensor of the other autonomous driving apparatus has been applied. The identification reinforcement portion may be the subject of identification by an external identification entity 50 (e.g., other autonomous driving apparatus) performing position identification, and may become a structure that reinforces identifiability for position identification.

Various autonomous driving apparatuses and a structure of the autonomous driving apparatus will be described in greater detail below.

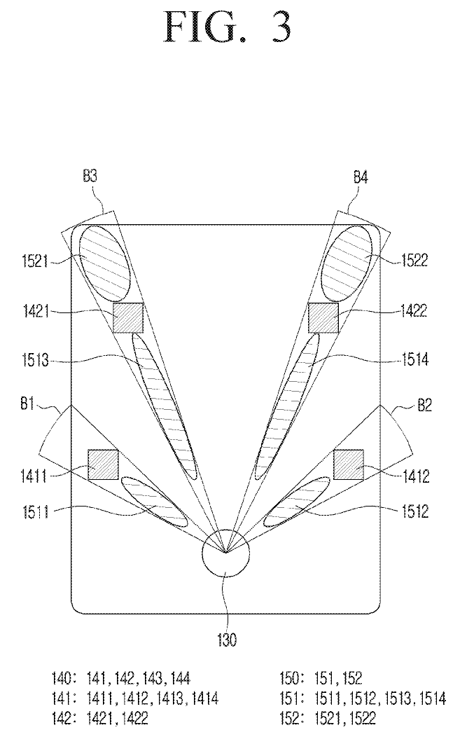

Referring to FIG. 2 and FIG. 3, the identification reinforcement portion 150 of the autonomous driving apparatus 100 may form blind areas B1 to B4 (referring to FIG. 3) that are obscured by the support portion 140 among position identification areas of the sensor 130.

The identification reinforcement portion 150 of the autonomous driving apparatus 100 may be positioned on the blind areas B1 to B4 (referring to FIG. 3) described above. The identification reinforcement portion 150 may be the subject of position identification by the external identification entity 50 that performs the position identification.

The identification reinforcement portion 150 may be performed with position identification for the autonomous driving apparatus 100 through the external identification entity 50. The autonomous driving apparatus 100 may also perform position identification for the external identification entity 50 or the like having the identification reinforcement portion 150.

The autonomous driving apparatus 100 may have, by the identification reinforcement portion 150, reinforced identifiability compared to when the identification reinforcement portion 150 is not provided in the autonomous driving apparatus 100. Because identification of the distance and position between the apparatuses can be performed easily and accurately due to the above, possibility of collision may be reduced.

As described, assuming that there is no identification reinforcement portion 150, the external identification entity 50 may have to make a determination by distorting the identification position to prevent/avoid collision according to a structural shape (e.g., a protrusion structure protruded toward the outside compared to a basic flat structure, a dent structure dented toward the inside, etc.) of the autonomous driving apparatus 100.

The external identification entity 50 may recognize the autonomous driving apparatus 100 as separated (spaced apart) even when the autonomous driving apparatus 100 is close to the external identification entity 50 according to a point at which position identification for the autonomous driving apparatus 100 is performed.

The sensor 130 of the autonomous driving apparatus 100 may be disposed on a top surface 111 of the first body 110. The support portion 140 of the autonomous driving apparatus 100 may be positioned distributed in each of a plurality of directions based on the position of the sensor 130 on the top surface 111 of the first body 110.

A first identification reinforcement part 151 of the identification reinforcement portion 150 may be positioned respectively between the support portions 140 and the sensor 130. A second identification reinforcement part 152 of the identification reinforcement portion 150 may be positioned between an edge portion and the support portion 140 on the top surface 111 of the first body 110.

The first support portion 141 of the support portion 140 may be positioned at a pre-set first position on the first body 110. The second support portion 142 of the support portion 140 may be positioned at a second position different from the first position on the first body 110.

FIG. 3 is a diagram illustrating a plan view of a state in which a sensor, a support portion, and an identification reinforcement portion are positioned on a first body among configurations of an autonomous driving apparatus according to various example embodiments.

As described, the first identification reinforcement part 151 may be positioned between the first support portion 141 and the sensor 130. The second identification reinforcement part 152 may be positioned between the second support portion 142 and an edge portion of the top surface 111.

A first_1 support portion 1411 of the first support portion 141 may be positioned at a pre-set one side on the first body 110. A first_2 support portion 1412 of the first support portion 141 may be positioned at a pre-set other side on the first body 110.

A second_1 support portion 1421 of the second support portion 142 may be positioned at a pre-set one side on the first body 110. A second_2 support portion 1422 of the second support portion 142 may be positioned at a pre-set other side on the first body 110.

A first_1identification reinforcement part 1511 of the first identification reinforcement part 151 may be positioned between the first_1 support portion 1411 and the sensor 130. A first_2 identification reinforcement part 1512 of the first identification reinforcement part 151 may be positioned between the first_2 support portion 1412 and the sensor 130.

A first_3 identification reinforcement part 1513 of the first identification reinforcement part 151 may be positioned between the second_1 support portion 1421 and the sensor 130. A first_4 identification reinforcement part 1514 of the first identification reinforcement part 151 may be positioned between second_2 support portion 1422 and the sensor 130.

As described, the first_3 identification reinforcement part 1513 and the first_4 identification reinforcement part 1514 among the first identification reinforcement part 151 may be installed with a first subsequent installation method which is a method installed subsequently if reinforcing position identifiability of the external identification entity 50 is necessary after the first_1 identification reinforcement part 1511 and the first_2 identification reinforcement part 1512 are first installed.

The first_3identification reinforcement part 1513 and the first_4 identification reinforcement part 1514 of the first identification reinforcement part 151 may be installed with a pre-installation method which is a method of being installed together with the first_1identification reinforcement part 1511 and the first_2 identification reinforcement part 1512 so that the position identifiability of the external identification entity 50 may be displayed at a high state from the beginning.

A second_1 identification reinforcement part 1521 of the second identification reinforcement part 152 may be positioned between the second_1 support portion 1421 and the sensor 130. A second_2 identification reinforcement part 1522 of the second identification reinforcement part 152 may be positioned between the second_2 support portion 1422 and the sensor 130.

The first_3 identification reinforcement part 1513 and the first_4 identification reinforcement part 1514 may be installed with a second subsequent method which is a method additionally installed for position identifiability to be reinforced after the first_1 identification reinforcement part 1511, the first_2 identification reinforcement part 1512, and the second identification reinforcement part 152 are first installed.

The sensor 130 may perform position identification for adjacent objects on a driving path for the first body 110 on the driving path before driving, while driving, and after driving. The external identification entity 50 may also perform position identification for the driving path and adjacent objects (e.g., a first structure, a second structure, the identification reinforcement portion 150, and the like of the autonomous driving apparatus 100) before driving, while driving, and after driving.

Although position identification of the external identification entity 50 being performed while driving is most important, it may be possible to have the position identification as described above performed constantly before driving and even after driving.

Through the above, it may be possible to have the external identification entity 50 perform a level of recognition for the autonomous driving apparatus 100 at a maximum level. The first body 110 may be able to basically perform a stop operation and an avoidance operation to prevent/avoid collisions with surrounding terrains or obstacles, and other driving objects according to sensing values of the sensor 130.

Because the external identification entity 50 performs a stop operation, an avoidance operation, and the like based on recognition of the identification reinforcement portion 150 and the like of the autonomous driving apparatus 100 on its own in addition to the stop operation and the avoidance operation of the autonomous driving apparatus 100, collision between both the external identification entity 50 and the autonomous driving apparatus 100 may be prevented/avoided complexly.

The autonomous driving apparatus 100 may not only be operated independently on an independently pre-set driving path, but also be operated together with a separate subject. The separate subject may include both a subject that did not perform driving on a driving path and an entity performing driving.

In order to recognize the autonomous driving apparatus 100 and prevent/avoid collisions with the autonomous driving apparatus 100 described, the separate subject may correspond to a subject capable of performing a stop operation, an avoidance operation, and the like on a driving path.

The separate subject described may be for recognizing the autonomous driving apparatus 100, and may include the external identification entity 50 and the like capable of performing the above-described position identification operation. The external identification entity 50 described above may identify a position of an outer side of the autonomous driving apparatus 100.

The external identification entity 50 may identify the position of the autonomous driving apparatus 100 through a first structure which is an external structure, the position of which is identified from the outside of the autonomous driving apparatus 100, and a second structure which is an internal structure that is positioned inside of the autonomous driving apparatus 100, the position of which is identifiable from the outside.

The identification reinforcement portion 150 of the autonomous driving apparatus 100 may be included in the above-described first structure or second structure. The external identification entity 50 may more easily recognize the position of the autonomous driving apparatus 100 by the identification reinforcement portion 150 installed in the autonomous driving apparatus 100.

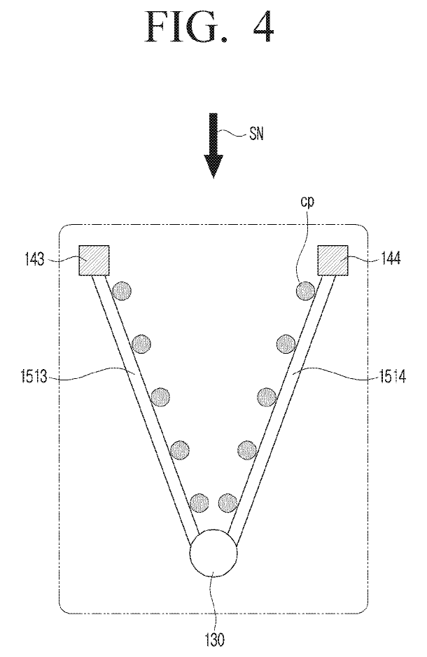

FIG. 4 is a diagram illustrating an example method by which the identification reinforcement portion 150 on the first body 110 provides position information to the external identification entity 50 among configurations of the autonomous driving apparatus 100 according to various example embodiments. FIG. 4 illustrates cloud points recognizable by a sensor (not shown) provided in the external identification entity 50 with respect to identification reinforcement portions 1513 and 1514.

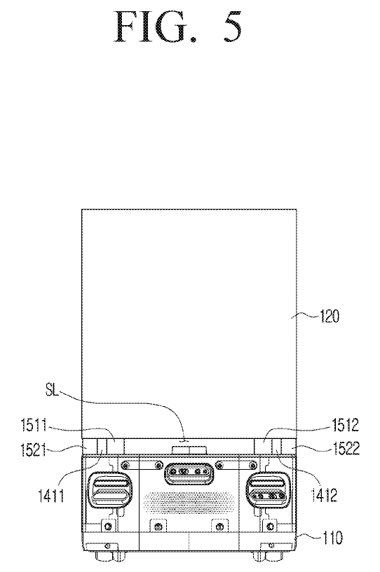

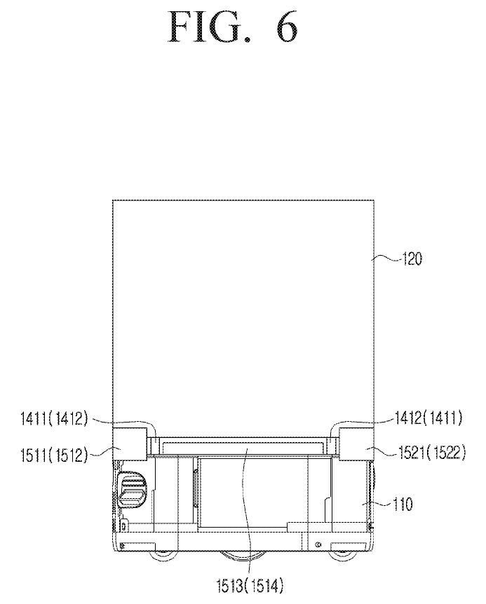

FIG. 5 is a diagram illustrating a front view of example positions for each configuration of the autonomous driving apparatus 100 according to various example embodiments. FIG. 6 is a diagram illustrating a side view of example positions for each configuration of the autonomous driving apparatus 100 according to various example embodiments.

Referring to FIG. 3 and FIG. 4, the above-described first support portion 141 may be positioned on the top surface 111 of the first body 110 toward one direction from a circumference portion of the sensor 130. The second support portion 142 may be positioned on the top surface 111 of the first body 110 toward the circumference portion of the sensor 130 based on the sensor 130.

If a plurality of support portions 1411, 1412, 1421, and 1422 is disposed distributed in the surrounding of the sensor 130 as in FIG. 3, blind areas B1, B2, B3, and B4 may be inevitably generated between the sensor 130 and each of the support portions 1411, 1412, 1421, and 1422.

In various embodiments of the disclosure, the identification reinforcement portions 150 may be disposed in all or partially for at least a portion among the blind areas B1, B2, B3, and B4 described.

Based on the above, because areas or directions that cannot be sensed due to the blind areas B1, B2, B3, and B4 may be utilized as installation spaces of the identification reinforcement portions 150, identifiability for the external identification entity 50 may be reinforced without decreasing sensing accuracy or efficiency.

For example, the external identification entity 50 may obtain cloud points which are information about the position of the autonomous driving apparatus 100 by the identification reinforcement portion 150 of the autonomous driving apparatus 100. The external identification entity 50 may perform stop and avoidance maneuvers with respect to the autonomous driving apparatus 100 based on the cloud points described above.

For example, the external identification entity 50 may perform the stop and avoidance maneuvers without distortion of identification by the structures (e.g., at least a portion of a protrusion structure, a concave structure, and the like formed at the first body 110, the second body 120, and the like) and the like of the autonomous driving apparatus 100 based on the cloud points.

The first_1 support portion 1411 and the first_2 support portion 1412 of the first support portion 141 may be positioned separated by a pre-set first separation distance between each other toward a front direction based on the sensor 130. The second_1 support portion 1421 and the second_2 support portion 1422 of the second support portion 142 may be positioned separated by a second separation distance.

The second separation distance may be a separation distance narrower than the first separation distance. The first_1 support portion 1411 and the first_2 support portion 1412 may be positioned on a same line so as to face each other. The first_1 support portion 1411 and the first_2 support portion 1412 may also be positioned away from the same line from each other.

The first_1 identification reinforcement part 1511, the first_2 identification reinforcement part 1512, the first_3 identification reinforcement part 1513, and the first_4 identification reinforcement part 1514 of the first identification reinforcement part 151 may be positioned based on positions of each of the sensor 130 and the first support portion 141, and the sensor 130 and the second support portion 142.

The second_1 identification reinforcement part 1521 and the second_2 identification reinforcement part 1522 of the second identification reinforcement part 152 may be positioned between the second support portion 142 and a corner portion of the top surface 111 of the first body 110. The first_1 identification reinforcement part 1511 of the first identification reinforcement part 151 may be positioned more forward than the sensor 130 toward one direction of the sensor 130.

The second_1 identification reinforcement part 1521 and the second_2 identification reinforcement part 1522 of the second identification reinforcement part 152 may also be positioned more forward than the sensor 130. The second_1 identification reinforcement part 1521 and the second_2 identification reinforcement part 1522 described above may be positioned more forward than the first_1 identification reinforcement part 1511 and the first_2 identification reinforcement part 1512.

However, the above correspond to an example, and the arrangement of the first identification reinforcement part 151 and the second identification reinforcement part 152 is not limited. For example, the first_1 identification reinforcement part 1511 and the first_2 identification reinforcement part 1512 of the first identification reinforcement part 151 may be positioned radially toward one direction of the sensor 130.

The second_1 identification reinforcement part 1521 and the second_2 identification reinforcement part 1522 of the second identification reinforcement part 152 may be positioned radially toward the opposite direction of the sensor 130 based on the sensor 130.

The positions of the first identification reinforcement part 151 and the second identification reinforcement part 152 may be positioned on the blind areas of the sensor 130 on the autonomous driving apparatus 100, and it may be preferable to not interfere with the position identification operation of the sensor 130.

If the external identification entity 50 performs sensing facing the first body 110 while simultaneously facing the first identification reinforcement part 151, cloud points may be obtained for an outer circumferential surface (e.g., an outer circumferential surface in a longitudinal direction, etc.) of at least any one among the first_1 identification reinforcement part 1511, the first_2 identification reinforcement part 1512, the first_3 identification reinforcement part 1513, and the first_4 identification reinforcement part 1514 of the first identification reinforcement part 151.

FIG. 7 is a block diagram illustrating an example configuration of the autonomous driving apparatus 100 according to various example embodiments of the disclosure. Referring to FIG. 7, the autonomous driving apparatus 100 may include the processor (e.g., including processing circuitry) 101, the memory 102, and a driving portion (e.g., including a motor) 103. The driving portion 103 may provide driving force for driving of the first body 110.

The processor 101 may include various processing circuitry and may control overall driving of the first body 110 controlled by controlling the driving portion 103 described above. The processor 101 and the memory 102 may be positioned at predetermined positions of the first body 110, the second body 120, and the like.

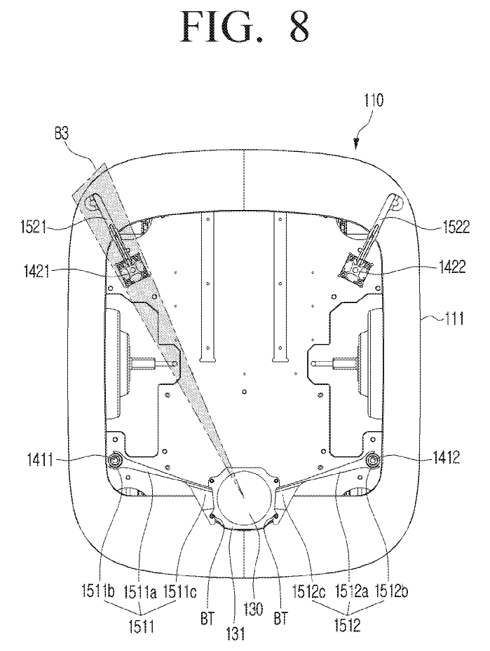

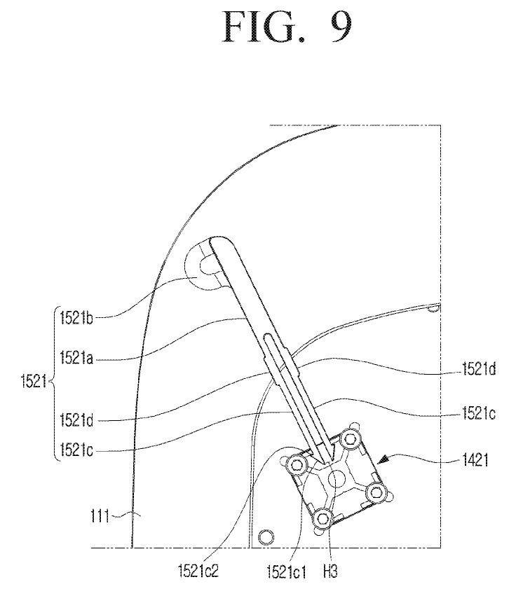

FIG. 8 is a diagram illustrating a plan view of the top surface 111 of the first body 110 according to various example embodiments. FIG. 9 is a diagram illustrating a portion of the top surface 111 of the first body 110 of the autonomous driving apparatus 100 according to various example embodiments.

Referring to FIG. 8 and FIG. 9, the first body 110 may include the top surface 111. The top surface described may be formed with an area opened in the upper and lower directions and an edge around the circumference thereof. The first_1 identification reinforcement part 1511 of the first identification reinforcement part 151 may have one direction thereof installed at the sensor 130 side.

The one direction of the first_1 identification reinforcement part 1511 may be installed on a sensor bracket 131 installed with the sensor 130 by a fastening member BT. A first body 1511c may be provided with an extension panel of a pre-set measure so as to be positioned in the edge of the first body 110 that is adjacent with the sensor 130.

The first_1 identification reinforcement part 1511 has a second body 1511b on the opposite side installed on the first_1 support portion 1411. The second body 1511b with its inner circumferential surface may be installed so as to surround at least a portion of the outer circumferential surface of the first_1 support portion 1411.

A third body 1511a of the first_1 identification reinforcement part 1511 may be provided so as to connect a space between the first body 1511c and the second body 1511b. The third body 1511a of the first_1 identification reinforcement part 1511 may be provided in a tapered form toward one direction.

The second_1 identification reinforcement part 1521 may be provided for one end 1521b that is positioned at the top surface 111 of the first body 110 to have magnetic properties. The other end 1521c of the second_1 identification reinforcement part 1521 may be installed so as to be detachable from the second_1 support portion 1421.

The second_1 support portion 1421 may correspond to a structure having an internal space H3. The other end 1521c of the second_1 identification reinforcement part 1521 may be provided at least in pairs. The other end 1521c of the second_1 identification reinforcement part 1521 may be in a pressed state by external force, and may enter into the internal space H3.

The other end 1521c of the second_1 identification reinforcement part 1521 may perform a restoring operation to its original position by elastic restoring force due to the external force being released after entering the internal space H3 described. The other end 1521c of the second_1 identification reinforcement part 1521 may be limited in separation from the internal space H3 by the restoring operation described.

For example, the other end 1521c of the second_1 identification reinforcement part 1521 may include an oblique portion 1521c1 that is tapered toward an entry direction into the internal space H3 and a base portion 1521c2 connected with the oblique portion 1521c1 described.

The other end 1521c of the second_1 identification reinforcement part 1521 may be entered into the internal space in a state in which external force has been applied. The other end 1521c of the second_1 identification reinforcement part 1521 may be formed with a protrusion area 1521d that is protruded toward the outside in a longitudinal direction in order to easily apply the external force described.

The other end 1521c of the second_1 identification reinforcement part 1521 may be a triangular shape, and detachment toward the outside may be limited due to the base portion 1521c2 being locked on the inner circumferential surface of the second_1 support portion 1421 when external force is released after entering into the internal space H3.

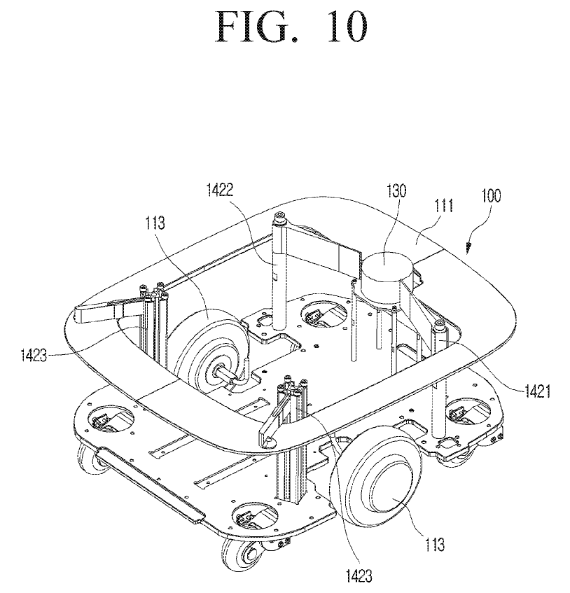

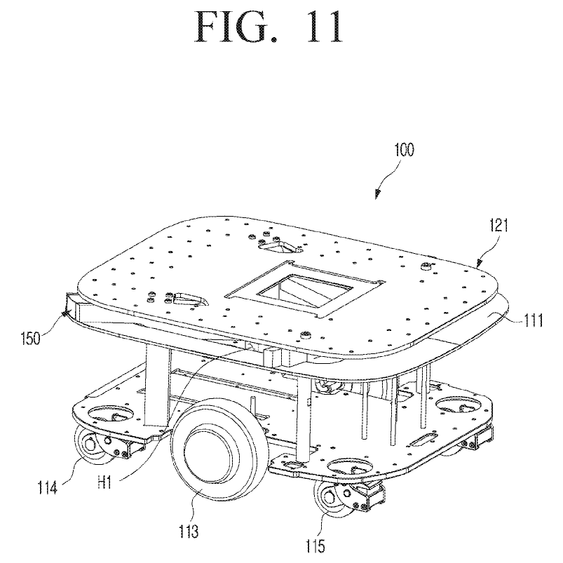

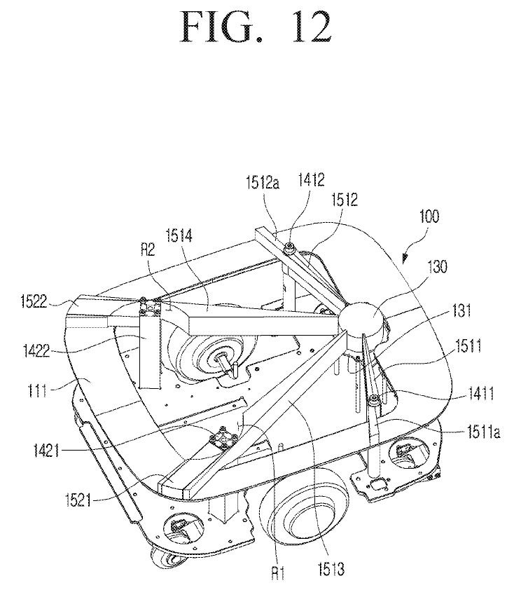

FIG. 10, FIG. 11, and FIG. 12 are perspective views illustrating the first body 110 among the configurations of the autonomous driving apparatus 100 according to various example embodiments. Referring to FIG. 10, FIG. 11, and FIG. 12, the first body 110 may be provided with a pair of left and right main wheels 113 and a pair of front and rear auxiliary wheels 114 and 115.

The main wheels 113 and the auxiliary wheels 114 and 115 of the first body 110 as described are examples, and the disclosure is not limited thereto. The first body 110 may be provided again with an additional panel type component 121 at the top surface 111.

The panel type component 121 as described may function to install the second body 120 on the first body 110. The above-described the first_3 identification reinforcement part 1513 and the first_4 identification reinforcement part 1514 may be formed as integrated types with the second_1 identification reinforcement part 1521 and the second_2 identification reinforcement part, respectively.

A first round area R1 may be formed between the first_3 identification reinforcement part 1513 and the second_1 identification reinforcement part 1521. In the first round area R1 described above, the second_1 support portion 1421 may be positioned. A second round area R2 may be formed between the first_4 identification reinforcement part 1514 and the second_2 identification reinforcement part 1522. In the second round area R2 described above, the second_2 support portion 1422 may be positioned.

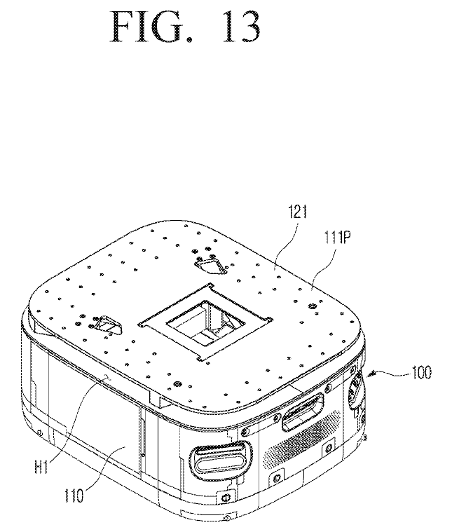

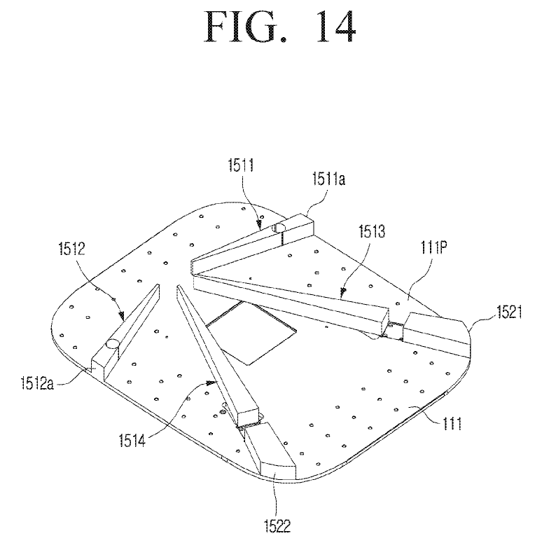

FIG. 13 and FIG. 14 are perspective views illustrating a state in which an upper plate 111p is installed in the autonomous driving apparatus 100 according to various example embodiments. Referring to FIG. 13 and FIG. 14, the autonomous driving apparatus 100 may include the upper plate 111p as the top surface 111 of the first body 110.

The upper plate 111p described may be a lower surface and may be positioned with the above-described identification reinforcement portion 150. Further, the identification reinforcement portion 150 described may be provided individually from the upper plate 111p, or provided integrally.

The identification reinforcement portion 150 provided at the upper plate 111p may be of a pre-set thickness, and may be provided so as to be protruded on the upper plate 111p. In this case, the first_1 identification reinforcement part 1511, the first_2 identification reinforcement part 1512, the first_3 identification reinforcement part 1513, and the first_4 identification reinforcement part 1514 on the upper plate 111p may be provided as an integrated type as a whole.

The first_1 identification reinforcement part 1511, the first_2 identification reinforcement part 1512, the first_3 identification reinforcement part 1513, and the first_4 identification reinforcement part 1514 on the upper plate 111p may also be provided with only a portion thereof as an integrated type rather than the whole as an integrated type.

The second_1 identification reinforcement part 1521 and the second_2 identification reinforcement part 1522 on the upper plate 111p may also be provided as an integrated type as a whole, or provided with only a portion thereof as an integrated type. Through the selection as described above, the identification reinforcement portion 150 may be installed in advance from the manufacturing stage of the autonomous driving apparatus 100.

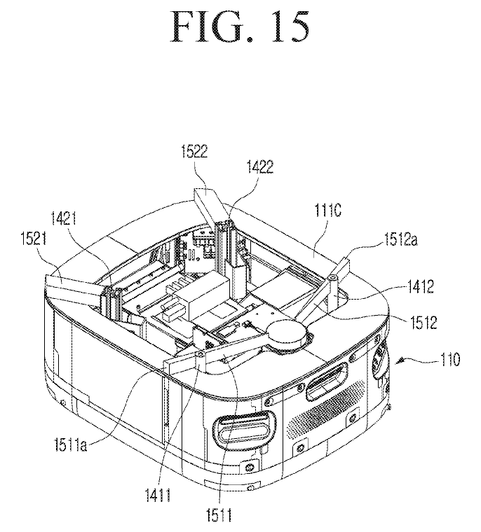

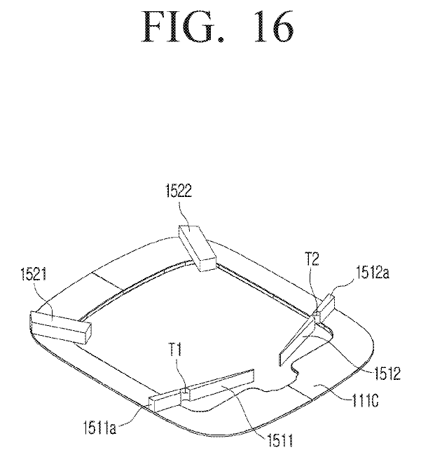

The identification reinforcement portion 150 may be additionally installed on the first body 110 after the manufacturing stage of the autonomous driving apparatus 100. FIG. 15 and FIG. 16 are diagrams illustrating a state in which an upper cover 111c is installed at the top surface 111 of the first body 110 according to one or more embodiments of the disclosure.

Referring to FIG. 15 and FIG. 16, the autonomous driving apparatus 100 described may include the upper cover 111c as the top surface 111 of the first body 110. It may also be installed separately at the top surface 111 of the first body 110 described.

The identification reinforcement portion 150 provided at the upper cover 111c may also be set to have a pre-set thickness toward an upper direction. The first_1 identification reinforcement part 1511, the first_2 identification reinforcement part 1512, the first_3 identification reinforcement part 1513, and the first_4 identification reinforcement part 1514 on the upper cover 111c may be provided as an integrated type as a whole.

The first_1 identification reinforcement part 1511, the first_2 identification reinforcement part 1512, the first_3 identification reinforcement part 1513, and the first_4 identification reinforcement part 1514 on the upper cover 111c may also be provided with only a portion thereof as an integrated type rather than the whole.

The second_1 identification reinforcement part 1521 and the second_2 identification reinforcement part 1522 on the upper cover 111c may also be provided as an integrated type as a whole, or only a portion thereof as an integrated type. Through the selection as described above, the identification reinforcement portion 150 may be installed in advance from the manufacturing stage of the autonomous driving apparatus 100.

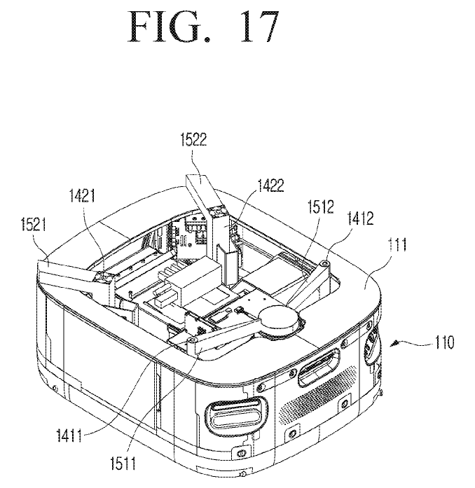

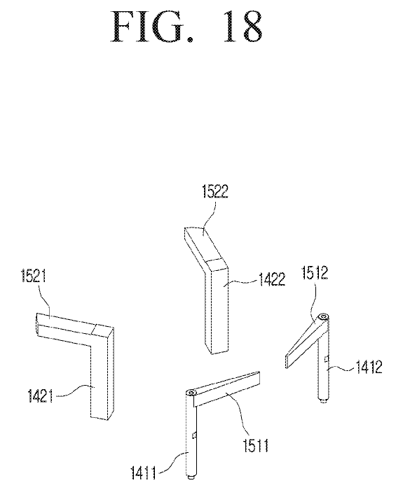

The identification reinforcement portion 150 may be additionally installed on the first body 110 after the manufacturing stage of the autonomous driving apparatus 100. FIG. 17 and FIG. 18 are diagrams illustrating an example of forms of the identification reinforcement portion 150 and the support portion 140 according to one or more embodiments of the disclosure.

Referring to FIG. 17 and FIG. 18, the autonomous driving apparatus 100 may have the first_1 support portion 1411, the first_2 support portion 1412, the second_1 support portion 1421, the second_2 support portion 1422, the first_1 identification reinforcement part 1511, the first_2 identification reinforcement part 1512, the first_3 identification reinforcement part 1513, and the first_4 identification reinforcement part 1514 be formed integrally between one another.

For example, the first_1 identification reinforcement part 1511 may be formed bent as an integrated type on the first_1 support portion 1411. The first_2 identification reinforcement part 1512 may be formed bent as an integrated type on the first_2 support portion 1412.

The second_1 identification reinforcement part 1521 may be formed bent as an integrated type on the second_1 support portion 1421. The second_2 identification reinforcement part 1522 may be formed bent as an integrated type on the second_2 support portion 1422.

The bent directions and lengths of the first_1 identification reinforcement part 1511, the first_2 identification reinforcement part 1512, the first_3 identification reinforcement part 1513, the first_4 identification reinforcement part 1514, the second_1 identification reinforcement part, and the second_2 identification reinforcement part 1522 may be set suitably within the above-described blind areas B1, B2, B3, and B4.

It may be preferable for the bent directions and lengths of the first_1 identification reinforcement part 1511, the first_2 identification reinforcement part 1512, the first_3 identification reinforcement part 1513, the first_4 identification reinforcement part 1514, the second_1 identification reinforcement part, and the second_2 identification reinforcement part 1522 to be provided without interference occurring in the sensor 130 of the autonomous driving apparatus 100 performing sensing.

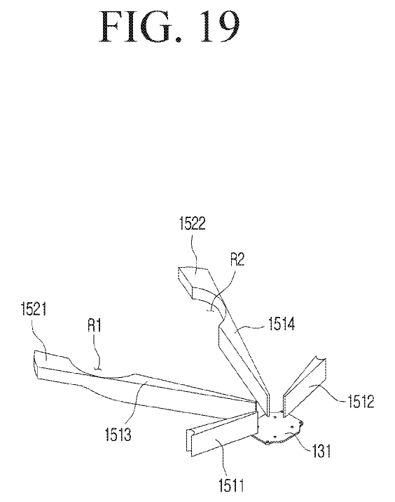

FIG. 19 is a diagram illustrating an example form of the identification reinforcement portion 150 according to various example embodiments. Referring to FIG. 19, the first_1 identification reinforcement part 1511, the first_2 identification reinforcement part 1512, the first_3 identification reinforcement part 1513, and the first_4 identification reinforcement part 1514 may be positioned at one end on the above-described sensor bracket 131 or a portion of an area in a longitudinal direction.

For example, the one end or the portion of the area in the longitudinal direction of the first_1 identification reinforcement part 1511, the first_2 identification reinforcement part 1512, the first_3 identification reinforcement part 1513, and the first_4 identification reinforcement part 1514 may be fastened on the sensor bracket 131 described as individual components, or installed as an integral module form.

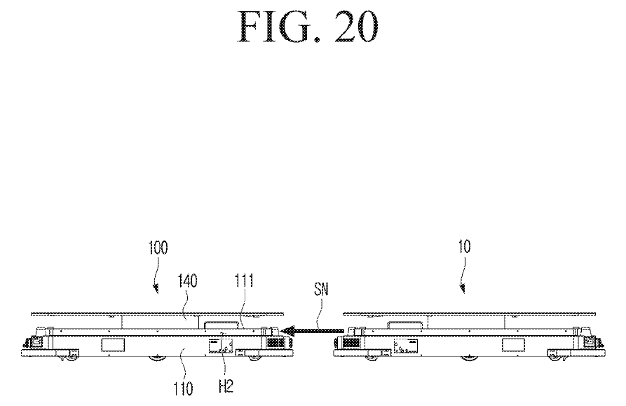

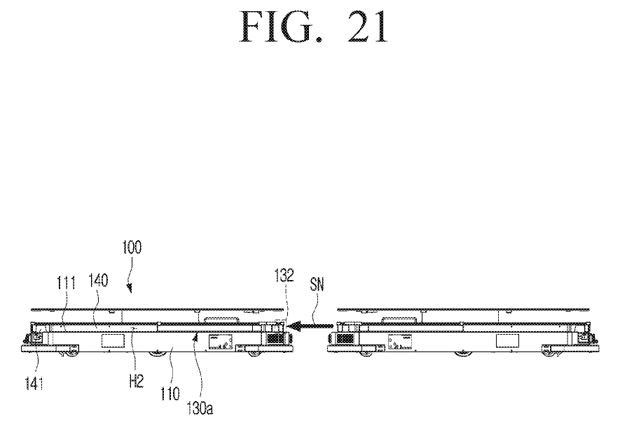

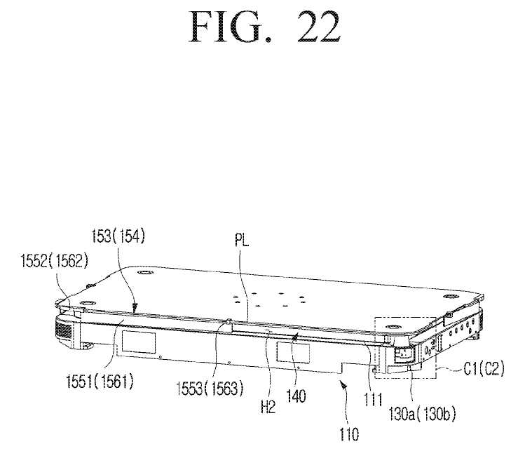

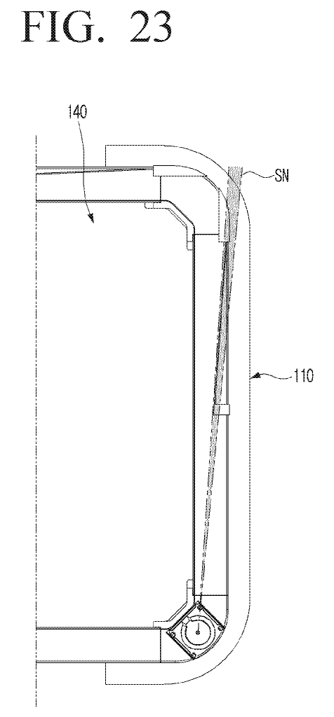

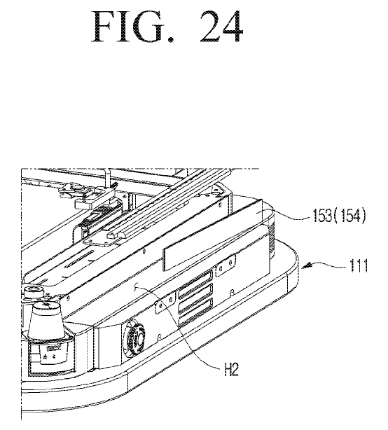

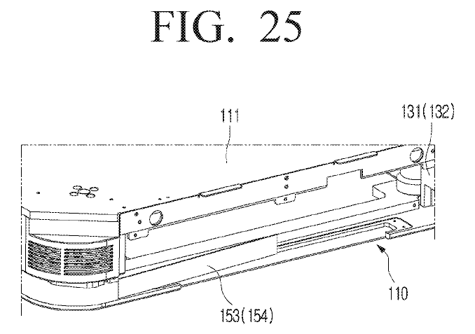

FIG. 20 and FIG. 21 are diagrams illustrating an example operating state of the autonomous driving apparatus 100 according to various example embodiments. FIG. 22 is a diagram illustrating an exterior of the autonomous driving apparatus 100 according to one or more embodiments of the disclosure. FIG. 23 is plane view illustrating a portion of the autonomous driving apparatus 100 according to one or more embodiments of the disclosure.

Parts similar with the above-described description will be omitted below and the disclosure will be described based on parts with technical features. Referring to FIG. 20, FIG. 21, and FIG. 22, the autonomous driving apparatus 100 may drive on a driving path.

The autonomous driving apparatus 100 may not be operated singularly on the driving path and may be driven together with other operating objects. Here, the other operating objects may include the above-described external identification entity 50, and the like. The external identification entity 50 may be an autonomous driving apparatus 100 provided separately from the autonomous driving apparatus 100, or the like.

The external identification entity 50 may perform identification to prevent/avoid collision on the driving path, and may be any apparatus so long as it is capable of performing a stop operation, an avoidance maneuvering operating, and the like based therefrom. The support portion 140 of the autonomous driving apparatus 100 as shown may be positioned on the center portion of the top surface 111.

The top surface 111 of the first body 110 of the autonomous driving apparatus 100 may include a rectangular cross-section form. The support portion 140 may be formed with a dent area H2 along at least a portion of the circumference portion thereof. The first body 110 may include a first corner point C1 and a second corner point C2.

The first corner point C1 may be one of two corner points in a diagonal direction of one side among the corner points on the circumference portion of the first body 110. The second corner point C2 may be the other one from the first corner point C1 described.

The sensor 130 may include a first sensor 130a positioned at the first corner point C1, a second sensor 130b positioned at the second corner point C2, and the like. The identification reinforcement portion 150 may include a third identification reinforcement part 153 and a fourth identification reinforcement part 154.

The third identification reinforcement part 153 may be positioned at the first corner point C1 and provided so as to correspond to the first sensor 130a. The fourth identification reinforcement part 154 may be positioned at the second corner point C2 and provided so as to correspond to the second sensor 130b.

The third identification reinforcement part 153 and the fourth identification reinforcement part 154 may respectively include first identification reinforcement bodies 1551 and 1561, second identification reinforcement bodies 1552 and 1562, and third identification reinforcement bodies 1553 and 1563. Referring to FIG. 22 and FIG. 23, the first identification reinforcement bodies 1551 and 1561 may be positioned on the above-described dent area H2.

The first identification reinforcement part 151 may be positioned in a tapered form from one end positioned at close distance with the sensor 130 toward the other end which is at a long distance from the sensor than the one end.

The second identification reinforcement bodies 1552 and 1562 of the identification reinforcement portion 150 may be positioned on the second corner point C2, and connected in one direction with a first identification reinforcement body 1551. The third identification reinforcement bodies 1553 and 1563 of the identification reinforcement portion 150 may be connected in the opposite direction of the first identification reinforcement body 1551.

As described, a third identification reinforcement body 1553 and 1563 may be installed on the support portion 140 and have a second identification reinforcement body 1552 fixed. The support portion 140 may be provided with a flange portion PL at an upper circumference portion thereof.

Although not directly shown, a third identification reinforcement body 1553 may include an inner circumferential surface shape of a “ㄷ” shape based on a longitudinal section thereof. The third identification reinforcement body 1553 and 1563 may accommodate the flange portion PL at the inner circumferential surface of the above-described shape and the same may be fixed thereon. Here, the fixing may not be limited to an insertion method, and application of other detachable methods may be possible.

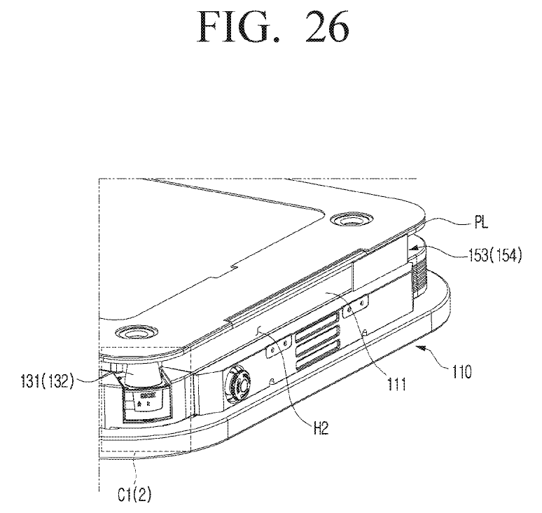

FIG. 24, FIG. 25, FIG. 26, and FIG. 27 are partial perspective views illustrating an example of a position at which the identification reinforcement portion 150 of the autonomous driving apparatus 100 is installed according to various example embodiments. Referring to FIG. 24, the identification reinforcement portion 150 may be installed on the above-described dent area H2.

For example, the above may be positioned on the dent area H2, but may be also positioned at the first position on the top surface 111 of the first body 110. Referring to FIG. 25, the identification reinforcement portion 150 may be at a lower position than the first position, and may be positioned at the second position which is a position on the circumference portion of the first body 110.

Referring to FIG. 26, the first identification reinforcement part 151 may be positioned at a corner of a side that is separated from the first sensor 130a on the dent area H2. The second identification reinforcement part 152 may also be positioned at a corner of a side that is separated from the second sensor 130b on the dent area.

Referring to FIG. 27, the above-described second identification reinforcement bodies 1552 and 1562 and third identification reinforcement bodies 1553 and 1563 of the identification reinforcement portion 150 may all be fixed together with the flange portion PL of the support portion 140. The fixing method herein may also be all methods that are detachable and demonstrate a certain fixing force as that described above.

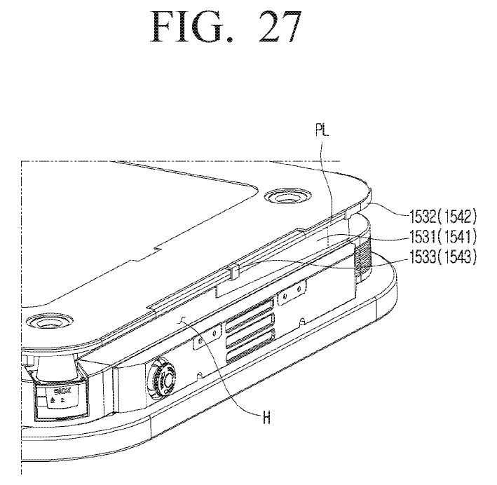

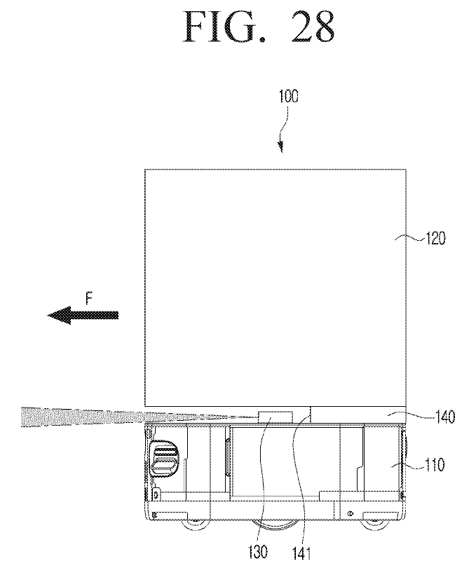

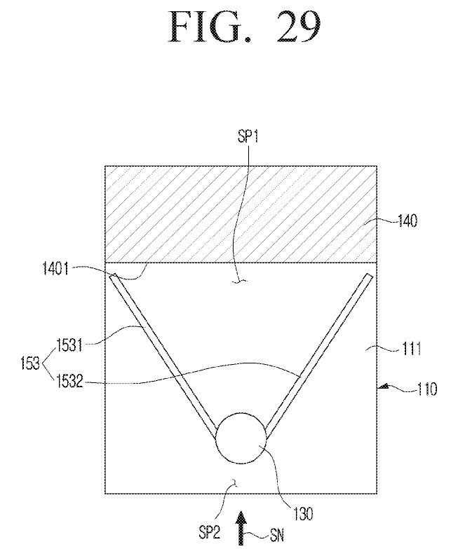

FIG. 28 is a diagram illustrating the autonomous driving apparatus 100 according to various example embodiments. FIG. 29 is a diagram illustrating a plan view of a state in which the sensor 130, the support portion 140, and the identification reinforcement portion 150 are positioned on the first body 110 among the configurations of the autonomous driving apparatus 100 according to various example embodiments.

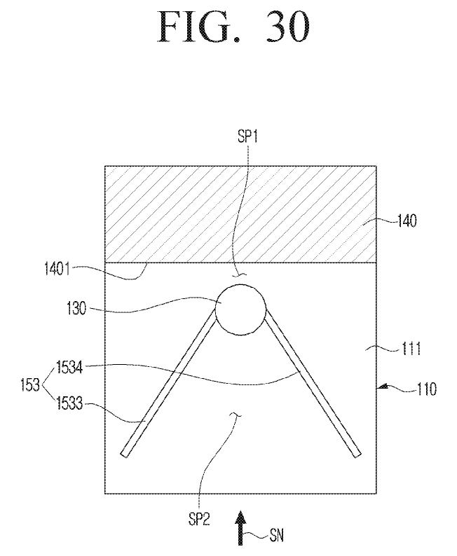

FIG. 30 is a diagram illustrating a plan view of a state in which the configurations of the autonomous driving apparatus 100 are positioned according to various example embodiments. Referring to FIG. 28, FIG. 29, and FIG. 30, the support portion 140 of the autonomous driving apparatus 100 may be separated from the sensor 130 on the top surface 111 of the first body 110.

The support portion 140 described may be provided with a finished surface 1401 that faces the sensor 130, and provided so as to finish at least a portion of one direction of the sensor 130. The identification reinforcement portion 150 may be positioned on a first in-between area SP1 which is between the sensor 130 and the finished surface 1401 on the top surface 111 of the first body 110.

The identification reinforcement portion 150 may include the third identification reinforcement part 153 for identifiability to be reinforced. The third identification reinforcement part 153 may include a third_1 identification reinforcement part 1531 and a third_2 identification reinforcement part 1532.

The third_1 identification reinforcement part 1531 may be positioned in a diagonal direction between the sensor 130 and the finished surface 1401 for identifiability to be reinforced. The third_2 identification reinforcement part 1532 may be positioned at a different position from the third_1 identification reinforcement part 1531 in a diagonal direction between the sensor 130 and the finished surface 1401 for identifiability to be reinforced.

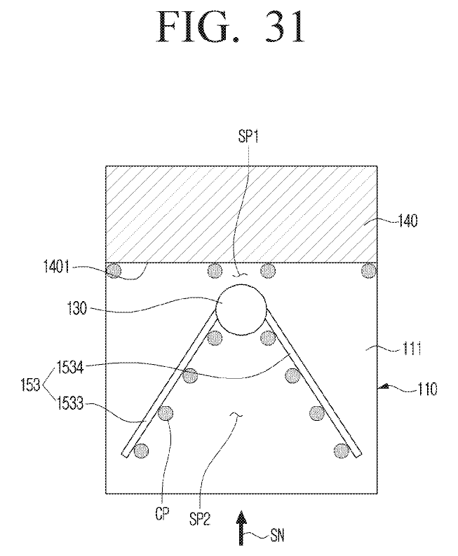

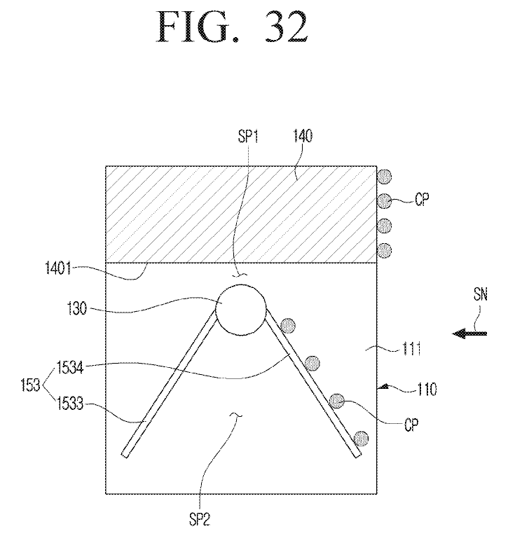

FIG. 31 and FIG. 32 are diagrams illustrating plan views illustrating an example method by which cloud points of the autonomous driving apparatus 100 are set according to various example embodiments of the disclosure.

Referring to FIG. 28 and FIG. 30, the identification reinforcement portion 150 may include the fourth identification reinforcement part 154. The fourth identification reinforcement part 154 may include a fourth_1 identification reinforcement part 1541, a fourth_2 identification reinforcement part 1542, and a fourth_3 identification reinforcement part 1543.

The fourth identification reinforcement part 154 may be positioned on a second in-between area SP2 which is between the sensor 130 and the opposite direction of the sensor 130 on the top surface 111 of the first body 110. The fourth identification reinforcement part 154 described may have identifiability of the external identification entity 50 reinforced.

The fourth_1 identification reinforcement part 1541 of the fourth identification reinforcement part 154 may be positioned in a diagonal direction on the second in-between area SP2 for identifiability to be reinforced. The fourth_2 identification reinforcement part 1542 of the fourth identification reinforcement part 154 may be positioned at a different position from the fourth_1 identification reinforcement part 1541 in a diagonal direction on the second in-between area SP2 for identifiability to be reinforced.

Referring to FIG. 31, assuming that a sensing direction SN of the external identification entity 50 is toward the front surface of the first body 110, the obtaining of cloud points herein may be obtained targeting at least a portion of the outer circumferential surface in a longitudinal direction of the fourth_1 identification reinforcement part 1541 and the fourth_2 identification reinforcement part 1542. The above may be obtained targeting the above-described finished surface 1401. At this time, the finished surface 1401 may be assumed as facing the sensing direction of the external identification entity 50.

Referring to FIG. 32, assuming that the sensing direction of the external identification entity 50 is a side surface of the first body 110, the obtaining of cloud points herein may be obtained targeting at least a portion of the outer circumferential surface in a longitudinal direction of the fourth_1 identification reinforcement part 1541 or the fourth_2 identification reinforcement part 1542. Further, the above may be obtained targeting a side surface of the support portion 140 rather than the above-described finished surface 1401. At this time, the finished surface 1401 may be assumed as not facing the sensing direction of the external identification entity 50.

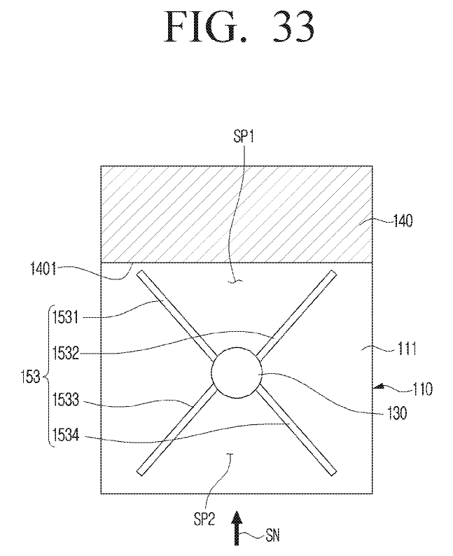

FIG. 33 is a diagram illustrating a plan view of a state in which the configurations of the autonomous driving apparatus 100 are positioned according to various example embodiments. Referring to FIG. 33, the support portion 140 of the autonomous driving apparatus 100 may be separated from the sensor 130 on the top surface 111 of the first body 110.

The support portion 140 may be provided with the finished surface 1401 facing the sensor 130, and provided so as to finish at least a portion of one direction of the sensor 130. The identification reinforcement portion 150 may include the third identification reinforcement part 153 and the fourth identification reinforcement part 154.

The third identification reinforcement part 153 may include the third_1 identification reinforcement part 1531 and the third_2 identification reinforcement part 1532. The fourth identification reinforcement part 154 may include the fourth_1 identification reinforcement part 1541 and the fourth_2 identification reinforcement part 1542. The third identification reinforcement part 153 may be positioned on the first in-between area SP1 which is between the sensor 130 and the finished surface 1401 on the top surface 111 of the first body 110.

The third_1 identification reinforcement part 1531 may be positioned in a diagonal direction between the sensor 130 and the finished surface 1401. The third_2 identification reinforcement part 1532 may be positioned at a different position from the third_1 identification reinforcement part 1531 in a diagonal direction between the sensor 130 and the finished surface 1401 for identifiability to be reinforced.

The fourth identification reinforcement part 154 of the identification reinforcement portion 150 may be positioned on the second in-between area SP2 which is between the sensor 130 and the opposite direction of the sensor 130 on the top surface 111 of the first body 110.

The fourth_1 identification reinforcement part 1541 of the fourth identification reinforcement part 154 may be positioned in a diagonal direction on the second in-between area SP2. The fourth_2 identification reinforcement part 1542 of the fourth identification reinforcement part 154 may be positioned at a different position from the fourth_1 identification reinforcement part 1541 in a diagonal direction on the second in-between area SP2.

Referring to FIG. 1, FIG. 2, and FIG. 3, an identification reinforcement unit detachable from the autonomous driving apparatus according to various example embodiments will be described. Referring to FIG. 1, FIG. 2, and FIG. 3, the identification reinforcement unit detachable from the autonomous driving apparatus may include the identification reinforcement portion 150.

The identification reinforcement portion 150 may include the first identification reinforcement part 151 and the second identification reinforcement part 152. The first identification reinforcement parts 151 may be positioned respectively between the support portions 140 and the sensor 130. The second identification reinforcement part 152 may be positioned between the edge portion on the top surface 111 of the first body 110 and the support portion 140.

The identification reinforcement portion 150 may be the subject of identification by the external identification entity 50 that performs position identification, and identifiability for position identification may be reinforced. The first identification reinforcement part 151, the second identification reinforcement part 152, and the third identification reinforcement part 153 may be provided to be protruded toward an upper direction in a pre-set thickness on the top surface 111 of the first body 110. Meanwhile, ‘F’ which is a symbol that is not explicitly designated throughout the disclosure may indicate a moving direction of the autonomous driving apparatus 100.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An autonomous driving apparatus, comprising:
a first body;
a second body separated from the first body;
a support configured to support the second body on the first body;
a sensor positioned in a separated space formed between the first body and the second body; and
an identification reinforcement portion comprising a longitudinal piece positioned on a blind area obscured by the support among sensing areas of a sensor,
wherein the identification reinforcement portion is subject to identification by an external identification entity comprising circuitry configured to perform position identification, and reinforces identifiability for the position identification.

2. The autonomous driving apparatus of claim 1,
wherein the sensor is disposed on a top surface of the first body,
wherein the support is positioned in plurality distributed in each of a plurality of directions based on a position of the sensor on a top surface of the first body, and
wherein the identification reinforcement portion comprises first identification reinforcement parts positioned between the support portions and the sensor, respectively.

3. The autonomous driving apparatus of claim 2,
wherein the identification reinforcement portion comprises a second identification reinforcement part positioned between an edge portion on a top surface of the first body and the support.

4. The autonomous driving apparatus of claim 3,
wherein the support comprises:
a first support positioned at a specified first position on the first body, and
a second support positioned at a second position different from the first position on the first body, and
wherein the first identification reinforcement part is positioned between the first support portion and a sensor, and
wherein the second identification reinforcement part is positioned between the second support portion and an edge portion of a top surface.

5. The autonomous driving apparatus of claim 4,
wherein the first support comprises a first first support portion at one side thereof and a second first support portion at another side thereof,
wherein the second support portion comprises a first second support portion at one side thereof, and a second second support portion at another side thereof, and
wherein the first identification reinforcement part comprises:
a first first identification reinforcement part positioned between the first first support and the sensor, and
a second first identification reinforcement part positioned between the second first support and the sensor.

6. The autonomous driving apparatus of claim 5,
wherein the first identification reinforcement part further comprises:
a third first identification reinforcement part positioned between the first second support and the sensor, and
a fourth first identification reinforcement part positioned between the second second support and the sensor, and
wherein the first identification reinforcement part configured for the identifiability to be reinforced after the first first identification reinforcement part and the second first identification reinforcement part are first installed.

7. The autonomous driving apparatus of claim 6,
wherein the second identification reinforcement part further comprises:
a first second identification reinforcement part positioned between the first second support and the sensor, and
a second second identification reinforcement part positioned between the second second support portion and the sensor,
wherein the third first identification reinforcement part and the fourth first identification reinforcement part are additionally installed for identifiability to be reinforced after the first first identification reinforcement part, the second first identification reinforcement part, and the second identification reinforcement part are first installed.

8. The autonomous driving apparatus of claim 1,
wherein the support is separated from the sensor on the top surface of the first body, provided with a finished surface facing the sensor, and provided to finish at least a portion of one direction of the sensor.

9. The autonomous driving apparatus of claim 8,
wherein the identification reinforcement portion comprises a third identification reinforcement part configured for identifiability to be reinforced by being positioned on a first in-between area between the sensor and the finished surface on the top surface of the first body.

10. The autonomous driving apparatus of claim 9,
wherein the third identification reinforcement part comprises:
a first third identification reinforcement part configured for identifiability to be reinforced by being positioned in a diagonal direction between the sensor and the finished surface, and
a second third identification reinforcement part configured for the identifiability to be reinforced by being positioned at a different position from the first third identification reinforcement part in a diagonal direction between the sensor and the finished surface.

11. The autonomous driving apparatus of claim 8,
wherein the identification reinforcement portion comprises a fourth identification reinforcement part configured for the identifiability to be reinforced by being positioned on a second in-between area between the sensor and an opposite direction of the sensor on a top surface of the first body.

12. The autonomous driving apparatus of claim 11,
wherein the fourth identification reinforcement part comprises:
a first fourth identification reinforcement part configured for identifiability to be reinforced by being positioned in a diagonal direction on the second in-between area, and
a second fourth identification reinforcement part configured for identifiability to be reinforced by being positioned at a different position from the first fourth identification reinforcement part in a diagonal direction on the second in-between area.

13. The autonomous driving apparatus of claim 1,
wherein the support is separated from the sensor on a top surface of the first body, and provided with a finished surface facing the sensor and provided to finish at least a portion of one direction of the sensor, and
wherein the identification reinforcement portion comprises:
a third identification reinforcement part configured for the identifiability to be reinforced by being positioned on a first in-between area which is between the sensor and the finished surface on a top surface of the first body, and
a fourth identification reinforcement part configured for identifiability to be reinforced by being positioned on a second in-between area between the sensor and an opposite direction of the sensor on a top surface of the first body.

14. The autonomous driving apparatus of claim 1,
wherein the support is positioned on a center portion of a top surface of the first body,
wherein the top surface of the first body comprises a rectangular cross-section,
wherein the support includes a dent along at least a portion of a circumference portion,
wherein the first body comprises a first corner point including one of two corner points in a diagonal direction of one side and a second corner point including the other thereof among corner points on a circumference portion of the first body,
wherein the sensor comprises a first sensor positioned at the first corner point, and a second sensor positioned at the second corner point, and
wherein the identification reinforcement portion comprises:
a third identification reinforcement part corresponding to the first sensor, and
a fourth identification reinforcement part positioned at the second corner point and corresponding to the second sensor.

15. An identification reinforcement unit detachable from an autonomous driving apparatus, the identification reinforcement unit comprising:
first identification reinforcement parts positioned between supports and a sensor, respectively, and
an identification reinforcement portion comprising a second identification reinforcement part positioned between an edge portion on a top surface of a first body and a support,
wherein the identification reinforcement portion is configured to be identified by an external identification entity configured to perform position identification, and to reinforce identifiability for the position identification, and
wherein the first identification reinforcement part and the second identification reinforcement part protrude toward an upper direction in a specified thickness on a top surface of the first body, and are detachable from the autonomous driving apparatus.

16. The identification reinforcement unit of claim 15,
wherein the support comprises:
a first support positioned at a pre-set first position on the first body, and
a second support positioned at a second position different from the first position on the first body, and
wherein the first identification reinforcement part is positioned between the first support and the sensor, and
wherein the second identification reinforcement part is positioned between the second support and an edge portion of a top surface.

17. The identification reinforcement unit of claim 16,
wherein the first support comprises a first_1 support at one side and a first_2 support at another side, and
wherein the second support comprises a second_1 support at one side and a second_2 support at another side, and
wherein the first identification reinforcement part comprises:
a first_1 identification reinforcement part positioned between the first_1 support and the sensor, and
a first_2 identification reinforcement part positioned between the first_2 support and the sensor.

18. The identification reinforcement unit of claim 15,
wherein the support is spaced apart from the sensor on a top surface of the first body, and is provided with a finished surface facing the sensor, and is provided to finish at least a portion of one side of the sensor.

19. The identification reinforcement unit of claim 15,
wherein the support is spaced apart from the sensor on a top surface of the first body,
and is provided with a finished surface facing the sensor, and is provided to finish at least a portion of one side of the sensor, and
wherein the identification reinforcement portion comprises:
a third identification reinforcement part positioned on a first in-between area between the sensor and the finished surface on the top surface of the first body to reinforce identifiability, and
a fourth identification reinforcement part positioned on a second in-between area between the sensor and an opposite side of the sensor on the top surface of the first body to reinforce identifiability.

20. The identification reinforcement unit of claim 15,
wherein the support is positioned on a center portion of a top surface of the first body,
wherein the top surface of the first body comprises a rectangular cross-sectional shape,
wherein the support is formed with a dent area along at least a portion of a circumference portion,
wherein the first body comprises, among corner points on a circumference portion of the first body, a first corner point which is one of two corner points in one diagonal direction, and a second corner point which is the other one,
wherein the sensor comprises a first sensor positioned at the first corner point, and a second sensor positioned at the second corner point, and
wherein the identification reinforcement portion comprises:
a third identification reinforcement part corresponding to the first sensor, and
a fourth identification reinforcement part positioned at the second corner point and corresponding to the second sensor.
